(19) United States
(12) Patent Application Publication
(10) Pub. No.: US 2014/0069666 A1
(43) Pub. Date: Mar. 13, 2014

(54) Helicopter Carried Aerial Fire Suppression System

(71) Applicant: Tuffbuilt Products Inc., Winnipeg (CA)

(72) Inventor: Jan Vetesnik, Winnipeg (CA)

(21) Appl. No.: 13/778,333

(22) Filed: Feb. 27, 2013

Related U.S. Application Data
(60) Provisional application No. 61/604,321, filed on Feb. 28, 2012.

(51) Int. Cl. A62C 3/02

(52) U.S. Cl. CPC A62C 3/0235
USPC 169/53

(57) ABSTRACT

An aerial fire suppression system for carrying by a helicopter features a liquid storage tank having a longitudinal dimension that equals or exceeds each other dimension of its shape, and an attachment arrangement for suspending the tank in an upright orientation in which the longitudinal dimension of the liquid storage tank depends downwardly away from the helicopter, thereby minimizing the distance to which the tank's contents can shift outward from the aircraft's longitudinal center of gravity for improved aircraft stability. A discharge boom for emitting fire suppressant media is pivotally supported on the tank, and a winch chain connects the tank to the helicopter to reduce allowable twisting of this tethered connection between the tank and helicopter.

### CROSS REFERENCE TO RELATED APPLICATIONS

This application claims benefit under 35 U.S.C. 119(e) of U.S. Provisional Patent Application Ser. No. 61/604,321, filed Feb. 28, 2012, the entirety of which is incorporated herein by reference.

### FIELD OF THE INVENTION

The present invention relates generally to fire suppression equipment, and more particularly to fire suppression systems configured for transport by a helicopter for use in aerial firefighting applications.

### BACKGROUND OF THE INVENTION

It is known in the art to employ aircraft in firefighting efforts, especially where access to, or conveyance of fire suppressing media to, the area concerned is proves otherwise difficult, impossible or dangerous. For example, it known to use airplanes or helicopters to dump or spray water in efforts to control wildfire, or to use helicopters to fight fires in high rise buildings by directing a stream of water or fire suppressing foam at the building.

Examples of prior art concerning helicopter carried fire suppression equipment include U.S. Pat. No. 3,714,987 of Mattson, U.S. Pat. No. 4,589,614 of Stevens, U.S. Pat. No. 4,979,571 of MacDonald, U.S. Pat. No. 6,003,782 of Kim et al., and U.S. Pat. No. 6,874,734 of Ramage et al.

Examples of prior art concerning compressed air system for generating fire suppressing foam include U.S. Pat. No. 6,733,004 of Crawley, and Applicant's own U.S. Application Publication 2010/0236799.

However, there remains room for improvement in the area of aircraft carried fire suppression systems.

### SUMMARY OF THE INVENTION

According to a first aspect of the invention there is provided an aerial fire suppression system for carrying by a helicopter, the system comprising:

a liquid storage tank having a three dimensional shape including a longitudinal dimension that equals or exceeds each other dimension of said three dimensional shape;

a delivery system connected to the liquid storage tank and operable to discharge liquid therefrom for use in fire suppression;

an attachment arrangement supported on the liquid storage tank and shaped and oriented for placement against the helicopter from therebeneath in order to suspend the liquid storage tank from the attachment arrangement in an upright orientation in which the longitudinal dimension of the liquid storage tank depends downwardly away from the helicopter; and

a tether connection feature supported on the liquid storage tank for connection of a tether between said connection feature and the helicopter for use in suspending the liquid storage tank and attachment arrangement from the helicopter and hoisting the attachment arrangement up thereagainst.

Preferably the delivery system comprises a foam generating apparatus operable to produce foam from the liquid and discharge said foam into an environment for fire suppression purposes.

Preferably there is provided a submersible filling mechanism supported on the liquid storage tank at a lower position distal to the attachment arrangement, the filling mechanism being operable to introduce water into the liquid storage tank under submersion of the submersible filling mechanism into a body of water.

Preferably the tether connection feature comprises a winch supported on the liquid storage tank, the tether having a first end connected to the winch for winding and deployment of the tether on and from the winch, and a second end selectively connectable to the helicopter.

Preferably the tether comprises a chain.

Preferably there is provided a non-swiveling connector at the second end of the tether.

The liquid storage tank may be narrower at a top end thereof adjacent the attachment arrangement than at an opposing bottom end of the liquid storage tank.

Preferably there is provided an outlet conduit having an inlet end fed by the delivery system and an opposing outlet end through which fire suppressant media is discharged, the outlet conduit being movably supported for pivoting thereof about at least one axis.

Preferably the outlet conduit is movably supported for pivoting thereof about two orthogonal axes.

Preferably there is provided a nozzle installed on the outlet end of the outlet conduit.

The system is used in combination with the helicopter, the attachment arrangement being held against the helicopter by the tether to suspend the system from the helicopter with the liquid storage tank depending downwardly away therefrom.

According to a second aspect of the invention there is provided an aerial fire suppression system for carrying by a helicopter, the system comprising:

a liquid storage tank;

a delivery system connected to the liquid storage tank and operable to discharge liquid therefrom for use in fire suppression;

an attachment arrangement connected on the liquid storage tank and shaped and oriented for placement against the helicopter from therebeneath to suspend the liquid storage tank from the attachment arrangement in a position beneath a fuselage of the helicopter; and

a winch connected to the liquid storage tank and the attachment arrangement; and

a tether chain having a first end connected to the winch for winding and deployment of the tether on and from the winch, and a second end selectively connectable to the helicopter for use in suspending the liquid storage tank and attachment arrangement from the helicopter and hoisting the attachment arrangement up thereagainst.

According to a third aspect of the invention there is provided an aerial fire suppression system for carrying by a helicopter, the system comprising:

a liquid storage tank;

a delivery system connected to the liquid storage tank and operable to discharge liquid therefrom for use in fire suppression;

an attachment arrangement supported on the liquid storage tank and shaped and oriented for placement against the helicopter from therebeneath in a position suspending the liquid storage tank from the attachment arrangement beneath a fuselage of the helicopter; and

an outlet conduit having an inlet end fed by the delivery system and an opposing outlet end through which fire suppressant media is discharged, the outlet conduit being movably supported for pivoting thereof about at least one axis.

According to a fourth aspect of the invention there is provided, in combination, a helicopter and an aerial fire suppression system comprising a liquid storage tank, a delivery system connected to the liquid storage tank and operable to discharge liquid therefrom for use in fire suppression, and an attachment arrangement connected on the liquid storage tank and shaped and oriented for placement against the helicopter from therebeneath to suspend the liquid storage tank from the attachment arrangement in a position beneath a fuselage of the helicopter; wherein the combination further comprises a winch connected to either the helicopter or the fire suppression system, and a tether chain having a first end connected to the winch for winding and deployment of the tether on and from the winch, and a second end selectively connectable to the other of the helicopter and the fire suppression system for use in suspending the liquid storage tank and attachment arrangement from the helicopter and hoisting the attachment arrangement up thereagainst.

### BRIEF DESCRIPTION OF THE DRAWINGS

In the accompanying drawing, which illustrates an exemplary embodiment of the present invention:

FIG. 1 is a schematic illustration of an aerial compressed-air foam fire suppression system for carrying by a helicopter.

FIG. 2 is a schematic illustration of the fire suppression system as carried by the helicopter.

### DETAILED DESCRIPTION

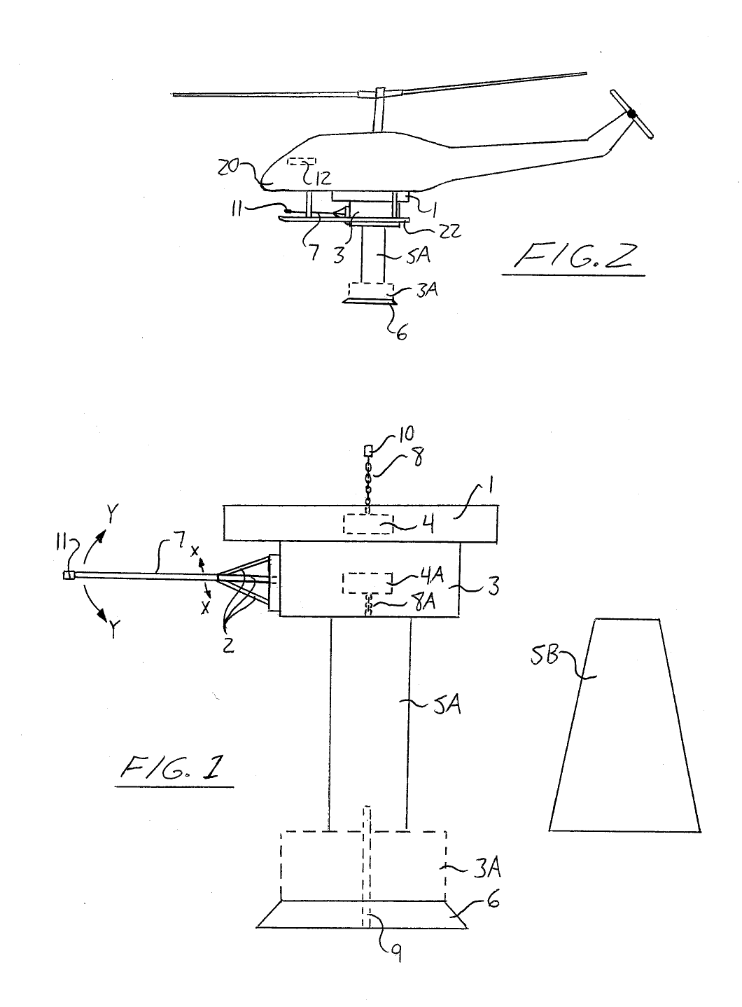

The aerial fire suppression system of FIG. 1 differs notably from the aforementioned prior art concerning helicopter carried fire suppression systems in that a water supply tank 5A of the system is oriented with its longitudinal dimension in an upright orientation. That is, the longest dimension of the tank's three dimensional shape does not lie parallel to the longitudinal axis of the helicopter when attached to the underside thereof like the prior art, but rather lies at a significant angle relative thereto, preferably at a right angle thereto, thus lying more parallel to the rotor axis of the helicopter than the longitudinal axis shared by the fuselage and tail of the aircraft. This is believed to present an advantage by minimizing the distance to which the tank's contents can shift outward from the aircraft's longitudinal center of gravity during maneuvering of the aircraft, thereby improving operator control over the aircraft while carrying the fire suppression system. Other improvements offered by the present invention will be realized from the further description below.

A foam generation system 3 of the illustrated embodiment is shown in solid lines at a position mounted atop the water supply tank 5A, while broken lines at 3A are used to illustrate an alternate position of the foam generation system at an opposing bottom end of the water supply tank 5A. The foam generation system may be similar to that aforementioned U.S. Pat. No. 6,733,004, the entirety of which is incorporated herein by reference. Accordingly, the foam generation system preferably features a pump acting to draw water from the water supply tank 5A and convey the same through a suitable line or duct to a mixer. Along the way to the mixer, an injector is operable to add a foaming agent to water moving therethrough. An air compressor directs compressed air into the mixer, where the water and incorporated foaming agent mixes with the stream of compressed air to generate a foam, which is conveyed onward through a rigid outlet conduit 7 that defines a discharge boom extending radially outward beyond the rotational path of the distal tips of the helicopter's rotor blades. The foam is discharged from the distal outlet end of the boom 7 through a nozzle 11 into the surrounding environment at a location outward from the downwash of the helicopter rotor.

To control the particular angle in which the foam is streamed from the discharge boom 7, the boom 7 is movably supported near its inlet end, which is connected to the outlet of the foam generating system 3. Use of a length of flexible conduit in this fluid connection between the mixer of the foam generating system and the boom is used to accommodate relative movement therebetween. Preferably, the boom 7 is pivotal about two orthogonal axes, each of which is also generally orthogonal to the longitudinal axis of the helicopter. This way, the boom 7 is pivotal in both generally vertical and generally horizontal planes when the helicopter is in a hovering action, where its longitudinal axis lies generally horizontal. Actuators 2 are operable to control the angular position of the boom in order to aim the output from the nozzle. Aiming the discharge of the foam through motion of the boom relative to the water tank and foam generating system means that the nozzle may have a fixed position relative to the boom conduit 7, i.e. with a main central axis of the nozzle in fixed alignment with the longitudinal axis of the boom 7. This is considered to present an advantage over the alternate configuration of a fixed boom with a movable nozzle, as pivoting of a movable nozzle out of alignment with the boom means that a reaction force resulting from the discharge of the foam from the nozzle is then out of alignment with the axis of the boom arm, thus creating a moment on the boom which cause a pitch, yaw or roll effect about the center of gravity of the combination of the aircraft and the attached fire suppression system.

An attachment or mounting frame 1 is mounted atop the housing of the foam generating system 3 so as to be carried on the water tank 5A in a position overlying the top end thereof for use in attaching the overall fire suppression system to the helicopter. A winch 4 is mounted to the attachment frame 1. The rotating drum of the winch 4 has a first end of a hoisting chain 8 attached to it so as to wind and unwind the chain 8 from the drum under rotation thereof in opposite directions about the drum's axis. The opposing second end of the chain 8 has a quick release connector attached thereto. To attach the fire suppression system to the helicopter, the quick release connector is coupled with a hard point on the underside or belly of the fuselage of the helicopter at or near the location of the helicopter's center of gravity along the helicopter's longitudinal axis. The hoist is driven to turn its drum in the retracting direction to wrap more of the chain 8 around the drum, thus taking up slack in the chain between the winch and the helicopter. With the helicopter hovering over the fire suppression system, this operation of the winch hoists the fire suppression off the ground, thereby suspending it from the helicopter, and continues to hoist the system upward toward the underside of the fuselage. This lifting action is continued until contact surfaces on the attachment frame are brought into contact against surfaces of the helicopter.

The use of a chain instead of a rope or cable as the tether between the helicopter and the fire suppression system limits the allowable degree of twisting of this tether around its longitudinal axis due to the limited degree of relative movement allowed about this axis between adjacent links of a chain. Together with a use of a quick release connector 10 that is attached to the free end of the chain in a non-swiveling manner relative to the longitudinal axis of the chain, this means that rotation of the fire suppression system around the longitudinal axis of the chain during hoisting of system up toward the underside of the helicopter will be minimized. Accordingly, using an attachment frame 1 configured for a particular helicopter make or model in order to present contact surfaces at suitable positions and orientations relative to one another to be conformingly placed against suitable contact points on that helicopter, and with the winch and chain positioned and oriented to facilitate coupling of the quick release connector to the hard point on the helicopter in an orientation corresponding to placement of the contact surfaces of the attachment frame against the contact points on the helicopter under sufficient tensioning of the chain under operation of the winch, the mounting of the fire suppression system on the underside of the helicopter can be achieved with minimal or no need for personnel to manually resist rotation of the fire suppression system about the chain axis during the lifting of the system upwardly to the aircraft.

A stabilizer base 6 may be mounted to the bottom end of the liquid storage tank 5A. Alternatively, if the foam generating system is mounted to the bottom of the tank 5A (as shown in broken lines at 3A) instead of at the top of the tank (as shown at 3), then the stabilizer base 6 may be mounted to the underside of the foam generating system. In the illustrated assembly, the tank 5A is a cylindrical tank that is notably greater in axial length than in diameter, preferably having a length at least twice the size of its diameter. The stabilizer presents a bottom face having a greater surface area than the bottom end of the tank 5A, thus providing a larger footprint for seating of the overall apparatus on the ground while in storage or while waiting for deployment. The base 6 also improves the stability of the system when seated at ground level by distributing a greater percentage of the system's overall weight to the bottom end thereof.

As shown at 5B, an alternative tank design may employ a tapered shape, for example a frustoconical configuration, that narrows in width or diameter moving along its longitudinal axis from the top end of the tank to the lower end of the tank. The wider bottom end of such a tank 5B may provide sufficient stability to the overall structure without the need for a separate base 6, as its larger surface area presents a greater footprint than the bottom of the smaller-diameter cylindrical tank 5A and also distributes more of the overall weight of the liquid contents of the tank toward the bottom end thereof.

The system may employ a tank-filling mechanism 9 operable to introduced water into the tank 5A through submersion of a lower portion of the system into a body of water, such as a pond or lake. The mechanism may feature a one-way valve arrangement that automatically opens under hydrostatic pressure, like those found at the bottom of the tank in aforementioned U.S. Pat. No. 3,714,987, which is incorporated herein by reference, or may feature a pump operable to convey water upward into the interior of the tank from the body. The tank filling mechanism may be mounted directly to the tank to perform a filling operation when the lower end of the tank is submerged, or may be mounted with the base 6 or a tank-bottom-mounted foam generation system 3A, with an output conduit of the refill mechanism directing water into the interior tank from such a location when that location is submerged. The upright orientation of the water tank's longitudinal dimension not only minimizes shifting of the tank's contents outward from the aircraft's center of gravity under movement of the helicopter, compared to prior art designs where the tank length runs longitudinally of the aircraft and the tank contents can thus shift significantly away from the aircraft's center of gravity under change of the aircraft's pitch, but also allows refill of the tank without lowering of the helicopter itself to the water level and without needing to deploy a refill hose or conduit into the body of water.

It will be appreciated that the contact surfaces of the attachment frame 1 may be configured for placement against points on the helicopter fuselage 20, landing gear 22 (wheels, skids, etc.) or a combination thereof. As an alternative to a separate attachment frame mounted over the tank, suitable contact points for placement against the aircraft and a suitable mounting location for the winch may alternatively be incorporated into the design of the housing or framework of the foam generation system, when same is located atop the tank, or into the design of the tank itself, for example when the foam generating system is instead mounted below the tank. However, use of a separate attachment frame would mean that different models of the fire suppression system could be produced with the same tank and same foam generation layout, which may help reduce minimized manufacturing costs. While FIG. 1 illustrates possible mounting of the foam generating system either exclusively above or exclusively below the tank 5A, other embodiments may have components of the foam generating system separately mounted at spaced apart locations along the tank, or mounted together at an intermediate location therealong.

The winch, chain and quick release connector are all preferably a part of the fire suppression system to make it a stand alone solution not requiring the addition of any specialized equipment to the aircraft itself. Such a stand alone embodiment preferably employs an onboard engine, for example a lightweight gasoline engine similar to those used for snowmobiles or ultralight aircraft, which may be mounted above the water tank as part of the foam generation system to lie closely beneath the helicopter when the system is in place on the aircraft. The engine may drive the water pump and air compressor of the foam generation system by direct-drive shafts, belt drives, gear drives, or hydraulic drives. In the case where a pump is located at or near the bottom of the water tank for use in re-filling thereof, the same engine may be used to drive this pump, for example by a hydraulic connection running from the above-tank engine down the bottom-mounted water refill pump. Actuators to control the boom could be electrically or hydraulically powered, for example using electricity generated by an alternator that is driven by the engine to power the actuators and the winch, or using a hydraulic pump driven by the engine.

A remote control panel 12 is wired or wirelessly linked to the foam generation system for operation of the system from within the occupant cabin of the aircraft, and for example may include controls of the type described in the aforementioned U.S. Pat. No. 6,733,004. Incorporated in the same panel, or defined separately therefrom, is a control for operation of the boom actuators 2 by an occupant (pilot, accompanying passenger, etc.) of the helicopter cabin, which for example may be provided in the form a joystick for directional control of the boom, and a control for operation of the winch 4 in either direction. In one embodiment, a second winch 4A and second chain hoist 8A may be used to couple the water tank 5A to the components thereabove instead of a fixed connection, whereby the water tank may be selectively lowered away from the attachment frame, and subsequently raised back up thereto as desired, without detachment or lowering of the attachment frame from its operational position against the underside of the helicopter.

A second set of controls may be provided to allow operation of the foam generation system and aiming of the boom from the ground, whether the second controls are provided as a stationary panel fixed to the system, or a remote unit (wired or wireless) operable at a distance from the rest of the system. The second set of controls may or may not include controls for operation of the one or more winches of the system.

It will be appreciated that advantageous features of the present invention may be employed independently of one another. For example, the upright orientation of the tank length may be employed regardless of whether the system is particularly configured to use compressed-air foam type fire suppression media or another media (e.g. non-foamed water), or whether the system employs a boom or nozzle type spray or other delivery method (e.g. dumping mechanism). Likewise, use of a chain hoist may be employed to minimize twisting of the tether and resulting relative rotation between the aircraft and the fire suppression system regardless of the particular tank orientation, fire suppression media and delivery mode of that media into the environment. Also, the pivoting boom for aiming of the fire suppression media may be used for foam or non-foam delivery regardless of the orientation of the tank and the type of attachment to the aircraft (permanent or releaseable; chain, cable, or rope; etc.).

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An aerial fire suppression system for carrying by a helicopter, the system comprising:
a liquid storage tank having a three dimensional shape including a longitudinal dimension that equals or exceeds each other dimension of said three dimensional shape;
a delivery system connected to the liquid storage tank and operable to discharge liquid therefrom for use in fire suppression;
an attachment arrangement supported on the liquid storage tank and shaped and oriented for placement against the helicopter from therebeneath in order to suspend the liquid storage tank from the attachment arrangement in an upright orientation in which the longitudinal dimension of the liquid storage tank depends downwardly away from the helicopter; and
a tether connection feature supported on the liquid storage tank for connection of a tether between said connection feature and the helicopter for use in suspending the liquid storage tank and attachment arrangement from the helicopter and hoisting the attachment arrangement up thereagainst.

2. The system of claim 1 wherein the delivery system comprises a foam generating apparatus operable to produce foam from the liquid and discharge said foam into an environment for fire suppression purposes.

3. The system of claim 1 comprising a submersible filling mechanism supported on the liquid storage tank at a position distal to the attachment arrangement, the filling mechanism being operable to introduce water into the liquid storage tank under submersion of the filling mechanism into a body of water.

4. The system of claim 1 wherein the tether connection feature comprises a winch supported on the liquid storage tank, the tether having a first end connected to the winch for winding and deployment of the tether on and from the winch, and a second end selectively connectable to the helicopter.

5. The system of claim 4, wherein the tether comprises a chain.

6. The system of claim 4 comprising a non-swiveling connector at the second end of the tether.

7. The system of claim 1 wherein the liquid storage tank is narrower at a top end thereof adjacent the attachment arrangement than at an opposing bottom end of the liquid storage tank.

8. The system of claim 1 comprising an outlet conduit having an inlet end fed by the delivery system and an opposing outlet end through which fire suppressant media is discharged, the outlet conduit being movably supported for pivoting thereof about at least one axis.

9. The system of claim 8 wherein the outlet conduit is movably supported for pivoting thereof about two orthogonal axes.

10. The system of claim 8 comprising a nozzle installed on the outlet end of the outlet conduit.

11. The system of claim 1 in combination with the helicopter, the attachment arrangement held against the helicopter by the tether to suspend the system from the helicopter with the liquid storage tank depending downwardly away therefrom.

12. An aerial fire suppression system for carrying by a helicopter, the system comprising:
a liquid storage tank;
a delivery system connected to the liquid storage tank and operable to discharge liquid therefrom for use in fire suppression;
an attachment arrangement connected on the liquid storage tank and shaped and oriented for placement against the helicopter from therebeneath to suspend the liquid storage tank from the attachment arrangement in a position beneath a fuselage of the helicopter; and
a winch connected to the liquid storage tank and the attachment arrangement; and
a tether chain having a first end connected to the winch for winding and deployment of the tether on and from the winch, and a second end selectively connectable to the helicopter for use in suspending the liquid storage tank and attachment arrangement from the helicopter and hoisting the attachment arrangement up thereagainst.

13. An aerial fire suppression system for carrying by a helicopter, the system comprising:
a liquid storage tank;
a delivery system connected to the liquid storage tank and operable to discharge liquid therefrom for use in fire suppression;
an attachment arrangement supported on the liquid storage tank and shaped and oriented for placement against the helicopter from therebeneath in a position suspending the liquid storage tank from the attachment arrangement beneath a fuselage of the helicopter; and
an outlet conduit having an inlet end fed by the delivery system and an opposing outlet end through which fire suppressant media is discharged, the outlet conduit being movably supported for pivoting thereof about at least one axis.

14. In combination, a helicopter and an aerial fire suppression system comprising a liquid storage tank, a delivery system connected to the liquid storage tank and operable to discharge liquid therefrom for use in fire suppression, and an attachment arrangement connected on the liquid storage tank and shaped and oriented for placement against the helicopter from therebeneath to suspend the liquid storage tank from the attachment arrangement in a position beneath a fuselage of the helicopter; wherein the combination further comprises a winch connected to either the helicopter or the fire suppression system, and a tether chain having a first end connected to the winch for winding and deployment of the tether on and from the winch, and a second end selectively connectable to the other of the helicopter and the fire suppression system for use in suspending the liquid storage tank and attachment arrangement from the helicopter and hoisting the attachment arrangement up thereagainst.
